(19) United States
(12) Patent Application Publication
(10) Pub. No.: US 2017/0185219 A1
(43) Pub. Date: Jun. 29, 2017

(54) TOUCH SCREEN DISPLAY DEVICE

(71) Applicant: Samsung Display Co., Ltd, Yongin-si (KR)

(72) Inventor: Chul KIM, Yongin-si (KR)

(21) Appl. No.: 15/393,015

(22) Filed: Dec. 28, 2016

(30) Foreign Application Priority Data
Dec. 28, 2015 (KR) 10-2015-0187540

(51) Int. Cl. G06F 3/041; G06F 3/044

(52) U.S. Cl. CPC G06F 3/0416; G06F 3/044; G06F 2203/04111

(57) ABSTRACT

A touch screen display device includes a touch panel including a first area having first driving electrodes and first sensing electrodes and a second area having second driving electrodes and second sensing electrodes, a driving unit applying driving signals to the first driving electrodes and the second driving electrodes, and a sensing unit receiving sensing signals generated by the applying of the driving signals through the first sensing electrodes and the second sensing electrodes, wherein the first area and the second area are electrically insulated from each other.

### RELATED APPLICATIONS

The present application claims priority under 35 U.S.C. 119(a) to Korean Patent Application No. 10-2015-0187540, filed on Dec. 28, 2015, in the Korean Intellectual Property Office, the entire contents of which are incorporated herein by reference in their entirety.

### BACKGROUND

1. Field

An aspect of the present disclosure relates to a self-capacitance touch screen and a display device having the same.

2. Description of the Related Art

Typically, a touch panel is arranged above a display device, and a user may directly or indirectly touch the touch panel with a hand or an object, thereby selecting instructions shown on the display with the hand or the object. The display device including the touch panel detects a touch position through the touch panel, receives the instructions from the touch position as an input signal, and drives in accordance with the input signal.

The display device including the touch panel does not require a separate input device that operates while being connected to the display device such as a keyboard or a mouse. Thus, the display device including the touch panel has been increasingly used.

Recently, the touch panel is also used in the display device to be arranged above the display panel that displays an image, and detect a position by receiving a predetermined input from the user.

### SUMMARY

According to an aspect of the present disclosure, there is provided a touch screen display device reducing the number of wires compared to a conventional self-capacitance method (self-cap) and increasing a reaction speed compared to a conventional mutual capacitance method (mutual cap).

In addition, according to an aspect of the present disclosure, there is a provided a touch screen display device having touch sensitivity corresponding to the characteristic of each of a plurality of areas.

According to an aspect of the present disclosure, there is provided a touch screen display device including a touch panel a first area including first driving electrodes and first sensing electrodes and a second area including second driving electrodes and second sensing electrodes, a driving unit applying driving signals to the first driving electrodes and the second driving electrodes, and a sensing unit receiving sensing signals generated by the applying of the driving signals through the first driving electrodes and the second sensing electrodes, wherein the first area and the second area are electrically insulated from each other.

According to an embodiment, the first driving electrodes may be arranged in a first direction, and the first sensing electrodes are arranged in a second direction intersecting the first direction.

The second driving electrodes may be arranged in the first direction and the second sensing electrodes are arranged in the second direction.

The first driving electrodes may be arranged at a first distance from each other and the second driving electrodes may be arranged at a second distance from each other, wherein the second distance may be different from the first distance.

The first driving electrodes may be arranged at a first distance from each other and the second driving electrodes may be arranged at a second distance from each other, wherein the first distance may be greater than the second distance.

The first sensing electrodes may be arranged at a first distance from each other and the second sensing electrodes may be arranged at a second distance from each other, wherein the first distance may be greater than the second distance.

The second area may surround the first area.

The touch panel may further include a base substrate in which the first driving electrodes and the second driving electrodes are arranged on an upper surface thereof, and the base substrate may include a flexible area and a non-flexible area adjacent to the flexible area.

The first area may be arranged in the non-flexible area.

The second area may be arranged in the flexible area.

The touch panel may further include a base substrate in which the first driving electrodes and the second driving electrodes are arranged on an upper face thereof, and the base substrate may include a bent area and a flat area adjacent to the bent area.

The first area may be arranged in the flat area.

The second area may be arranged in the bent area.

According to another aspect of the present disclosure, there is provided a touch screen display device including a touch panel including a plurality of areas each including driving electrodes and sensing electrodes, a driving unit applying driving signals to the driving electrodes and the sensing electrodes, and a sensing unit receiving sensing signals generated by the applying of the driving signals through the sensing electrodes, wherein two adjacent areas of the plurality of area are electrically insulated from each other.

Each of the driving electrodes may be arranged in a first direction, and each of the sensing electrodes may be arranged in a second direction intersecting the first direction.

Each of driving electrodes in a first area may be arranged at a first distance from each other, and each of driving electrodes in a second area of the two adjacent areas may be arranged at a second distance from each other, wherein the first distance and the second distance may be different.

Each of the sensing electrodes in a first area may be arranged at a first distance from each other, and each of sensing electrodes in a second area of the two adjacent areas may be arranged at a second distance from each other, wherein the first distance and the second distance may be different.

### BRIEF DESCRIPTION OF THE DRAWINGS

FIG. 1 is a schematic block view illustrating a display device according to an embodiment of the present disclosure.

FIG. 2 is a schematic concept view illustrating a touch panel shown in FIG. 1.

FIG. 3 is a schematic concept view illustrating a touch panel according to another embodiment of the present disclosure.

FIG. 4 is a schematic concept view illustrating a touch panel according to an alternative embodiment of the present disclosure.

FIG. 5 is a perspective view illustrating a display device according to another embodiment of the present disclosure.

FIG. 6 is a plan view illustrating the display device shown in FIG. 4.

FIG. 7 is a cross-sectional view taken along line I-I′ of FIG. 6.

### DETAILED DESCRIPTION

The particular structural or functional explanation with respect to the inventive concept of the invention disclosed in the specification is illustrative only for the purpose of describing the embodiment according to the inventive concept of the present invention. In other words, the invention is not limited to an embodiment disclosed below and may be implemented in various forms and the scope of the invention is not limited to the following embodiments

While embodiments are described with reference to the accompanying drawings, it is to be understood that various changes and modifications may be made in the invention without departing from the spirit and scope thereof. Furthermore, it should be understood that the invention is not limited to the specific embodiments thereof, and various changes, equivalences and substitutions may be made without departing from the scope and spirit of the invention.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention.

It should be understood that, when it is described that an element is “coupled” or “connected” to another element, the element may be directly coupled or directly connected to the other element or coupled or connected to the other element through a third element. On the contrary, it should be understood that when an element is referred to as being “directly connected to” or “directly coupled to” another element, another element does not intervene therebetween. Other expressions which describe the relationship between components, that is, “between” and “directly between”, or “adjacent to” and “directly adjacent to” should be interpreted in the same manner.

The terminology used herein is for the purpose of describing particular embodiments only and is not intended to be limiting of the present invention. As used herein, singular forms are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

Hereinafter, the various embodiments of the present invention will be described in detail with reference to the attached drawings.

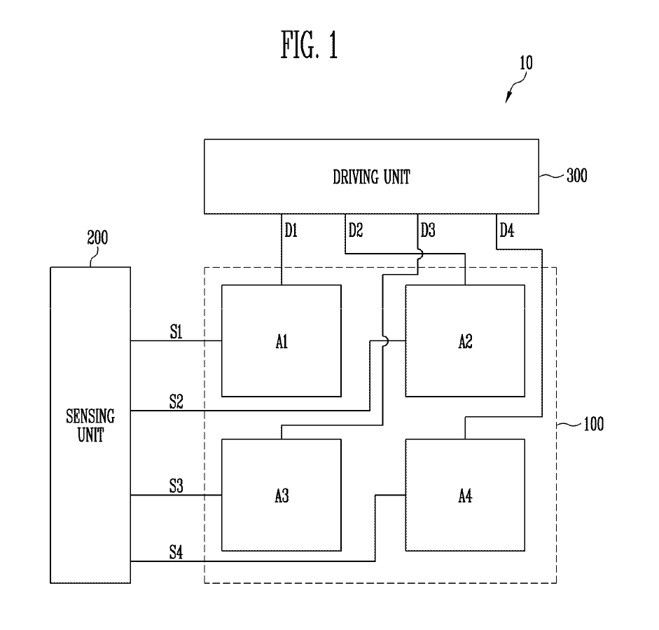

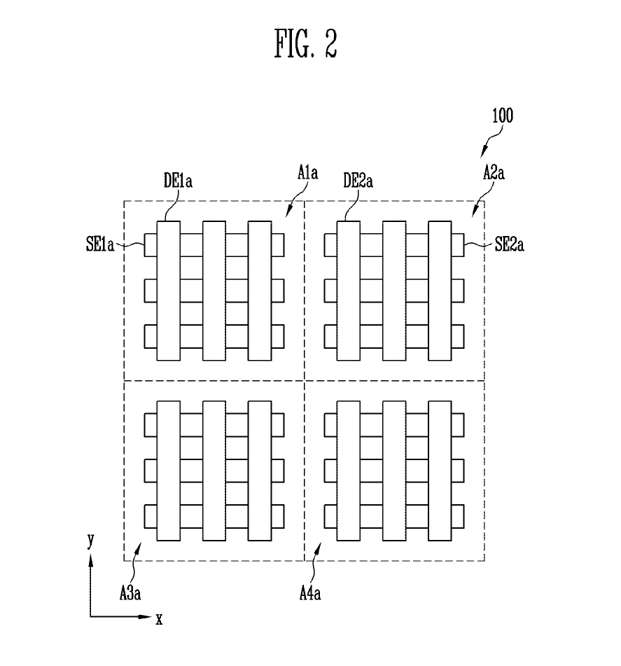

FIG. 1 is a schematic block view illustrating a display device according to an embodiment of the present disclosure and FIG. 2 is a schematic concept view illustrating a touch panel shown in FIG. 1.

Referring to FIG. 1, a touch screen display device 10 according to an embodiment of the present disclosure may include a touch panel 100, a sensing unit 200, and a driving unit 300.

The touch panel 100 may include a plurality of areas A1, A2, A3 and A4 and each of the plurality of areas A1, A2, A3 and A4 may include driving electrodes and sensing electrodes.

It is illustrated that the touch panel 100 includes the four areas A1, A2, A3 and A4. However, it is an exemplary case for the convenience of explanation and the number of areas included in the display panel 100 is not limited thereto. In addition, each of a first area A1, a second area A2, a third area A3 and a fourth area A4 may collectively include first areas A1a, A1b, A1c and A1d, second areas A2a, A2b, A2c and A2d, third areas A3a, A3b, A3c and A3d and fourth areas A4a, A4b, A4c and A4d.

The sensing unit 200 may receive sensing signals from the sensing electrodes through sensing lines S1 through S4.

The driving electrodes included in the plurality of areas may be connected to the driving unit 300 through driving lines D1 through D4. The driving electrodes may receive driving signals from the driving unit 300 through connected driving lines D1 through D4.

The driving unit 300 may supply the driving signals to the driving electrodes through the driving lines D1 through D4. That is, the driving unit 300 may supply the driving signal to the driving electrodes included in each of the plurality of areas through the driving lines D1 through D4.

According to an embodiment, the driving unit 300 may concurrently supply the driving signal to all driving electrodes included in the first area A1 through the fourth area A4.

According to another embodiment, the driving unit 300 may supply the driving signal to the driving electrodes included in each of the first area A1 through the fourth area A4 in a different order. For example, the driving unit 300 may supply the driving signal to the driving electrodes included in the first area A1, and sequentially supply the driving signal to the driving electrodes included in the second areas A2, the third areas A3, and the fourth area A4.

Referring to FIG. 2, the driving electrodes and the sensing electrodes included in each of the plurality of areas A1a, A2a, A3 and A4 are arranged.

The first area A1a may include first driving electrodes DE1a and first sensing electrodes SE1a. The first driving electrodes DE1a may be arranged in a first direction (an x-axis direction), and the first sensing electrodes SE1a may be arranged in a second direction (a y-axis direction) intersecting the first driving electrodes DE1a.

In addition, the second area A2a may include second driving electrodes DE2a and second sensing electrodes SE2a. The second driving electrodes DE2a may be arranged in the first direction and the second sensing electrodes SE2a may be arranged in the second direction.

According to an embodiment, at least two of the plurality of areas may be insulated from each other. For example, the first area A1a and the second area A2a may be insulated from each other. That is, the first driving electrodes DE1a and the second driving electrodes DE2a may be electrically separated from each other, and the first sensing electrodes SE1a and the second sensing electrode SE2a may be electrically separated from each other.

Therefore, the first driving electrodes DE1a and the second driving electrodes DE2a may receive the driving signal from the driving unit 300 through the different driving lines. In addition, the first sensing electrodes SE1a and the second sensing electrodes SE2a may supply the sensing signal to the sensing unit 200 through the different sensing lines.

According to an embodiment, the plurality of areas may be insulated from one another. Therefore, the plurality of areas A1a, A2a, A3a, and A4a may be connected to driving lines and sensing lines different from each other (i.e. none of the plurality of areas share the same driving line nor the same sensing line).

A mutual capacitance may be formed at interconnections of the driving electrodes and the sensing electrodes.

For example, the mutual capacitance may be formed at interconnections of the first sensing electrodes SE1a and the first driving electrode DE1a.

The mutual capacitance may be changed when the interconnections are touched by a finger (directly or indirectly). More specifically, when one of the interconnections of the first sensing electrodes SE1a and the first driving electrodes DE1a is touched by the finger, the finger may cause blocking of an electro line between the first driving electrode DE1a and the first sensing electrode SE1a.

As a result, a magnitude of the mutual capacitance may be reduced and a voltage level of the sensing signal may be changed correspondingly. The sensing unit 200 may detect the voltage change of the sensing signal and detect a touch position.

In addition, the driving unit 300 may be arranged with the number of driving lines corresponding to the number of driving electrodes and the sensing unit 200 may be arranged with the number of sensing lines corresponding to the number of sensing electrodes. The number of interconnections may be expressed by multiplying the number of driving electrodes by the number of sensing electrodes.

For example, the area A1a may include three first driving electrodes DE1a and three first sensing electrodes SE1a. The driving unit 300 may be connected to the first driving electrodes DE1a through three driving lines and the sensing unit 200 may be connected to the first sensing electrodes SE1a through three sensing lines. Therefore, nine interconnections may exist.

If a touch electrode using a self-cap method is arranged in the first area A1a, nine touch electrodes may be arranged to detect the touch positions of the nine interconnections. The touch electrodes may transmit the sensing signals through the different wires from one another. Therefore, nine wires connected to the touch electrodes may be required.

However, the touch screen display device 10 according to an embodiment of the present disclosure may detect the touch position in the first area A1 by using three driving lines connected to the first driving electrodes DE1a and three wires connected to the first sensing electrodes SE1a.

That is, according to the present disclosure, the number of wires required for detecting the touch position may be reduced as compared to the self-cap method. Thus, according to the present disclosure, the cost required for manufacturing the touch panel may be reduced and the circuit design may be easily made.

In addition, the driving electrodes and the sensing electrodes may be arranged to be divided into each region, so that small sized electrodes may be used. Therefore, the size of a parasitic capacitor generated between electrodes may be reduced.

For example, each of the first sensing electrode SE1a and the second sensing electrode SE2a may be formed in a smaller size than an electrode connected to the first sensing electrode SE1a and the second sensing electrode SE2a. Therefore, the size of a first parasitic capacitance generated in a first sensing electrode SE1a and the second sensing electrode SE2a which are insulated from each other may be smaller than that of a second parasitic capacitance generated in a first sensing electrode SE1a and the second sensing electrode SE2a which are connected to each other.

As such, the present disclosure may reduce the size of the parasitic capacitance and stably generate the sensing signal, thereby detecting an exact touch position of the user.

In addition, the areas of embodiments of the present disclosure are insulated from one another, thereby having a shorter charging time of the mutual parasitic capacitance than the mutual cap method that uses the driving electrodes connected to one another in the first direction and the sensing electrodes connected to one another in the second direction which are not divided into insulated areas. Therefore, an instant sensing signal may be generated in accordance with the touch operation of the user within the short charging time of the present disclosure.

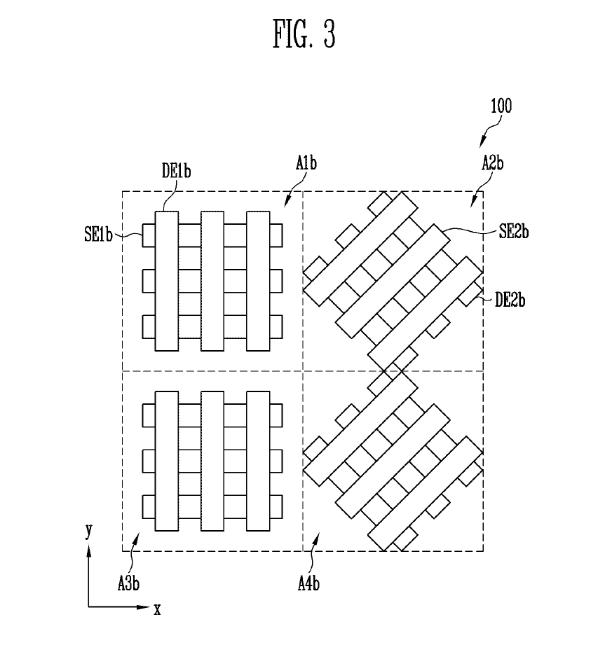

FIG. 3 is a schematic concept view illustrating a touch panel according to another embodiment of the present disclosure.

Referring to FIG. 3, the driving electrodes and the sensing electrodes included in each of the plurality of areas A1b, A2b, A3b and A4b may be arranged.

The first area A1b may include first driving electrodes DE1b and first sensing electrodes SE1b. The first driving electrodes DE1b may be arranged in the first direction (an x-axis direction), and the first sensing electrodes SE1b may be arranged in the second direction (a y-axis direction) intersecting the first driving electrodes DE1b.

In addition, the second area A2b may include second driving electrodes DE2b and second sensing electrodes SE2b. The second driving electrodes DE2b may be arranged in a third direction which does not intersect or is not in parallel with the first direction, and the second sensing electrodes SE2b may be arranged in a fourth direction intersecting the third direction.

The first area A1b and the second area A2b may be insulated from each other. The first area A1b and the second area A2b may detect the touch position by using the mutual cap method which is similar to that described in FIG. 2. Thus, the detailed description will be omitted to avoid repetition.

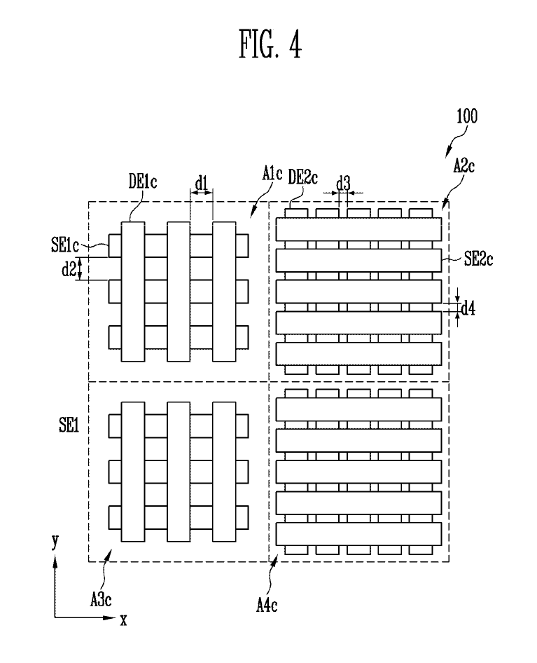

FIG. 4 is a schematic concept view illustrating a touch panel 100 according to an alternative embodiment of the present disclosure.

Referring to FIG. 4, the driving electrodes and the sensing electrodes included in each of the plurality of areas A1c, A2c, A3c, and A4c may be arranged.

Each of the plurality of areas may include the driving electrodes and the sensing electrodes arranged at different distances.

For example, a first area A1c may include first driving electrodes DE1c arranged at a first distance d1 interposed therebetween and first sensing electrodes SE1c arranged at a second distance d2 interposed therebetween. A second area A2c may include second driving electrodes DE2c arranged with a third distance d3 interposed therebetween and second sensing electrodes SE2c arranged at a fourth distance d4 interposed therebetween.

The first distance d1 and the third distance d3 may be different from each other, and the second distance d2 and the fourth distance d4 may be different from each other.

For example, the third distance d3 may be smaller or greater than the first distance d1. Furthermore, the fourth distance d4 may be smaller or greater than the second distance d2.

According to an embodiment, the touch panel 100 may further include a base substrate in which the driving electrodes and the sensing electrodes are arranged on an upper surface thereof, and the base substrate may further include a flexible area and a non-flexible area adjacent to the flexible area.

The flexible area may be bent or curved. Thus, the touch area to be detected may be increased or reduced. Therefore, the flexible area may require a larger number of touch positions for sensing than the non-flexible area.

The touch screen display device 10 according to an embodiment of the present disclosure may detect the exact touch position of the user by increasing the number of interconnections arranged in the flexible area.

That is, the number of interconnections may be increased by densely arranging the driving electrodes and the sensing electrodes arranged in the flexible area, and increasing the number of driving electrodes and the sensing electrodes.

For example, when the first area A1c is arranged in the non-flexible area, and a second area A2c is arranged in the flexible area, the first area A1c and the second area A2c have the same area, but the second area A2c may include a larger number of driving electrodes and sensing electrodes than the first area A1c.

The first area A1c may include three first driving electrodes DE1c arranged at the first distance d1 and the second driving electrodes DE2c arranged at the second distance d2. In addition, the second area A2c may include five second driving electrodes DE2c arranged at the third electrode d3 and five second sensing electrodes SE2c arranged at the fourth distance d4.

The first area A1c may include nine interconnections, and the second area A2c may include twenty-five interconnections. That is, the number of touch positions detected in the second area A2c may be greater than that in the first area A1c.

Therefore, the touch screen display device 10 of the present disclosure may detect the exact or near exact touch position of the user even though the second area A2c is bent or folded.

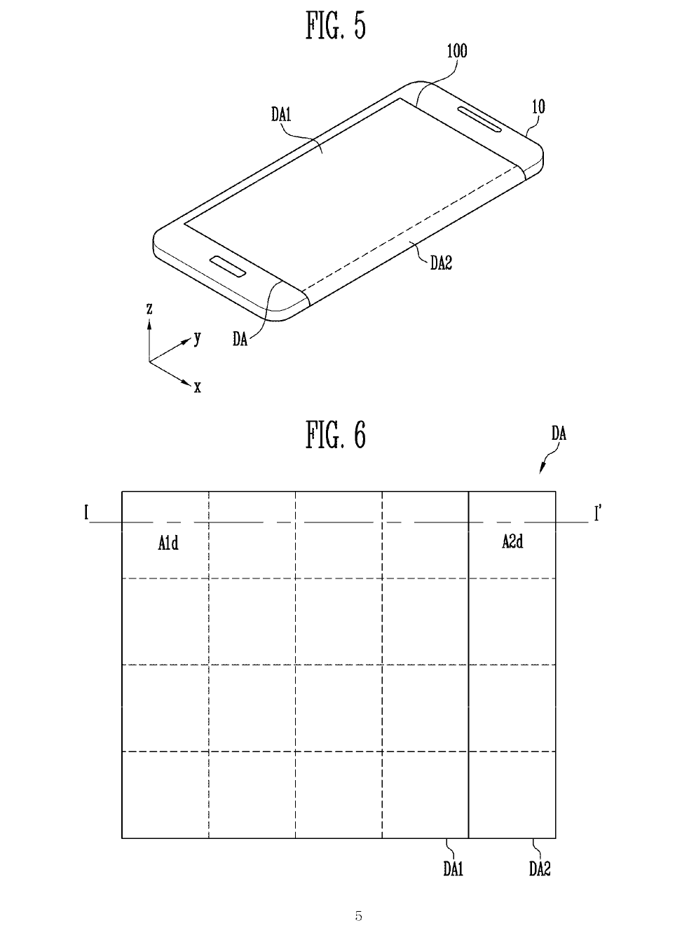

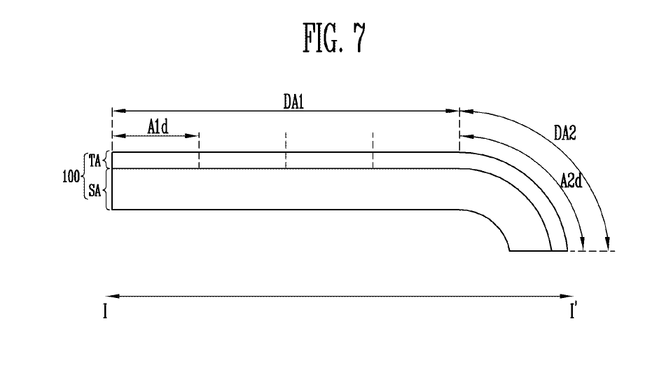

FIG. 5 is a perspective view illustrating a touch screen display device according to another embodiment of the present disclosure, FIG. 6 is a plan view illustrating a display panel shown in FIG. 5, and FIG. 7 is a cross-sectional view taken along line I-I′ of FIG. 6.

For the convenience of explanation, the first display area DA1 may be in parallel with a surface formed by the x-axis and the y-axis, and an image may be provided in a z-axis direction in the touch screen display device 10. In addition, the z-axis direction is designated as an upper direction, and the direction opposite to the-z axis direction is designated as a lower direction. However, the direction of each axis may be converted into another direction since it is a relative concept. For example, in FIG. 5, the z-axis direction in which the image is displayed is designated as the upper direction. However, the z-axis direction (or a direction where the image is displayed) may be designated as the lower direction or a side direction rather than the upper direction.

Referring to FIGS. 5 to 7, the touch screen display device 10 may include the touch panel 100 having a touch area TA and a substrate SA.

The touch panel 100 may include a first display area DA1 at a front side of the touch panel 100 and a second display area DA2 extending from one side of the first area DA1 and embodied as a bent shape on a side of the display panel.

For example, the first display area DA1 may have a rectangular shape including two pairs of sides parallel to each other as viewed in a plan view. One pair of sides may be longer than the other pair of sides.

In an embodiment of the present disclosure, the first display area DA1 and the second display area DA2 may have a rectangular shape with a pair of short-sides and a pair of long sides, and the extending direction of the long side is designated as the y-axis direction, the extending direction of the short side is designated as the x-axis direction, but present disclosure is not limited thereto.

The first display area DA1 may be embodied as a flat panel display area and the second display area DA2 may be embodied as a bent display area without damage through a thin and flexible substrate like a piece of paper.

That is, the display panel 100 including the first display area DA1 having a flat shape and the second display area DA2 implemented with a bent shape below an operational radius of curvature may be attached to the screen display device 10.

According to an embodiment, the second display area DA2 may be implemented as a shape with flexible movement such as a flexible display.

For example, the first display area DA1 may be implemented as a rigid area without flexibility, and the second display area DA2 may be implemented as a flexible area with flexibility.

The term “with flexibility” or “without flexibility” and “flexible” or “rigid” relatively present the nature of the display panel 100. That is, the expression “without flexibility” and “rigid” do not indicate only the solid area without the flexibility, but also the rigid area having smaller flexibility than the flexible area.

The first display area DA1 and the second display area DA2 each may include the plurality of areas.

The first display area DA1 may include sixteen areas and the second display area DA2 may include four areas, but this is an exemplary case for the convenience of the explanation, and the number of areas included in the first display area DA1 and the second display area DA2 are not limited thereto.

Each of the plurality of areas may include the driving electrodes and the sensing electrodes and detect the touch operation of the user by using the mutual cap method. Each of the plurality of areas may be electrically insulated from each other.

That is, first driving electrodes DE1d and first sensing electrodes SE1d included in the first area A1d may be electrically separated from second driving electrodes DE2d and second sensing electrodes SE2d arranged in the second area A2d. In addition, the first driving electrodes DE1d may be arranged at a first distance apart from each other than the distance between each of the second driving electrodes DE2d, and the first sensing electrodes SE1d may be arranged at a first distance apart from each other than the distance between each of the second sensing electrodes SE2d. As a result the second area A2d may have the interconnections arranged more compactly than the first area A1d.

A touch area of the second area A2d may be bent by a bent substrate, but the touch position detected in the second area A2d may be as exact as the touch position detected in the first area A1d due to the interconnections arranged compactly.

The touch screen display device according to an embodiment of the present disclosure may provide a touch panel including driving electrodes and sensing electrodes and a plurality of areas arranged to be insulated from each other.

The touch screen display device according to an embodiment of the present disclosure may require a smaller number of wires and detect the touch operation of the user more quickly than the self-cap method.

The touch screen display device according to an embodiment of the present disclosure may provide a touch panel in which each of the plurality of areas includes the driving electrodes and the sensing electrodes in different numbers. As a result, the touch screen display device may accurately detect the touch operation of the user in a specific area, for example, a flexible area, a bent area, etc.

Although the present disclosure has been described in reference to the embodiments shown in the drawings, it will be understood by a person of ordinary skill in the art that various modifications and equivalents may be made. Therefore, the true technical protection scope of the present disclosure will be defined by the technical spirit within the scope of claims.

What is claimed is:

1. A touch screen display device, comprising:
a touch panel including a first area having first driving electrodes and first sensing electrodes and a second area having second driving electrodes and second sensing electrodes;
a driving unit applying driving signals to the first driving electrodes and the second driving electrodes; and
a sensing unit receiving sensing signals generated by the applying of the driving signals through the first sensing electrodes and the second sensing electrodes,
wherein the first area and the second area are electrically insulated from each other.

2. The touch screen display device of claim 1, wherein the first driving electrodes are arranged in a first direction, and the first sensing electrodes are arranged in a second direction intersecting the first direction.

3. The touch screen display device of claim 2, wherein the second driving electrodes are arranged in the first direction and the second sensing electrodes are arranged in the second direction.

4. The touch screen display device of claim 1, wherein the first driving electrodes are arranged at a first distance from each other and the second driving electrodes are arranged at a second distance from each other, wherein the second distance is different from the first distance.

5. The touch screen display device of claim 1, wherein the first driving electrodes are arranged at a first distance from each other and the second driving electrodes are arranged at a second distance from each other, wherein the first distance is greater than the second distance.

6. The touch screen display device of claim 1, wherein the first sensing electrodes are arranged at a first distance from each other and the second sensing electrodes are arranged at a second distance from each other, wherein the first distance is greater than the second distance.

7. The touch screen display device of claim 1, wherein the second area surrounds the first area.

8. The touch screen display device of claim 1, wherein the touch panel further comprises a base substrate in which the first driving electrodes and the second driving electrodes are arranged on an upper surface thereof, and
the base substrate includes a flexible area and a non-flexible area adjacent to the flexible area.

9. The touch screen display device of claim 8, wherein the first area is arranged in the non-flexible area.

10. The touch screen display device of claim 8, wherein the second area is arranged in the flexible area.

11. The touch screen display device of claim 1, wherein the touch panel further comprises a base substrate in which the first driving electrodes and the second driving electrodes are arranged on an upper face thereof, and
the base substrate includes a bent area and a flat area adjacent to the bent area.

12. The touch screen display device of claim 11, wherein the first area is arranged in the flat area.

13. The touch screen display device of claim 11, wherein the second area is arranged in the bent area.

14. A touch screen display device, comprising:
a touch panel including a plurality of areas each including driving electrodes and sensing electrodes;
a driving unit applying driving signals to the driving electrodes and the sensing electrodes; and
a sensing unit receiving sensing signals generated by the applying of the driving signals through the sensing electrodes,
wherein two adjacent areas of the plurality of area are electrically insulated from each other.

15. The touch screen display device of claim 14, wherein each of the driving electrodes is arranged in a first direction, and each of the sensing electrodes is arranged in a second direction intersecting the first direction.

16. The touch screen display device of claim 14, wherein driving electrodes in a first area are arranged at a first distance from each other, and driving electrodes in a second area of the two adjacent areas are arranged at a second distance from each other, wherein the first distance and the second distance are different.

17. The touch screen display device of claim 14, wherein sensing electrodes in a first area are arranged at a first distance from each other, and sensing electrodes in a second area are arranged at a second distance from each other, wherein the first distance and the second distance are different.
